(19) United States
(12) Patent Application Publication
(10) Pub. No.: US 2025/0161125 A1
(43) Pub. Date: May 22, 2025

(54) Tactical Rescue Transfer Device

(71) Applicant: Dean Robert Kirschner, Cockeysville, MD (US)

(72) Inventor: Dean Robert Kirschner, Cockeysville, MD (US)

(21) Appl. No.: 18/916,963

(22) Filed: Oct. 16, 2024

Related U.S. Application Data
(60) Provisional application No. 63/653,552, filed on May 30, 2024.

(51) Int. Cl. A61G 1/01; A61G 1/003; A61G 1/044; A61G 1/048

(52) U.S. Cl. CPC A61G 1/01; A61G 1/003; A61G 1/044; A61G 1/048

(57) ABSTRACT

A Tactical Rescue/Transfer Device includes two mesh netting panels joined by a coil vertical zipper (fastening system) from top to bottom of the device allowing for safe, expedient patient rescue/transfers, extrication of a patient or provide safe, expedient transfers of a patient with minimal risk to patient and/or provider safety.

### CROSS-REFERENCE TO RELATED APPLICATIONS

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### Technical Field

This disclosure relates to emergency and non-emergency transfer of patients in on-scene, health care environments, educational settings, recreational settings, home health care, military operations, mass-casualty scenes, animal transfer, and coroner/cadaver operations, expediting the transfer and mitigating potential harm to the patient and those involved in the transfer of the patient.

The movement of a patient in an emergency environment requires efficiency, expediency, minimal risk of further injury to a patient, and mitigating risk of injury to rescuing personnel. These factors are compounded and magnified in situations such as water rescue events, backwoods rescues, hospital units, tight and narrow spaces, military operations, movement of the elderly, infirmed, or other injuries that prevent self-ambulation.

In a hospital, home health care, nursing facility, or health care facility, the transfer of a patient involves minimal patient movement to avoid further injury to the patient, to avoid causing further pain or discomfort to the patient, and to avoid causing injury to healthcare or first responder personnel in the process of lifting and moving a patient.

Prior art patient transfer devices have been developed. These have included a solid sheet with straps along the perimeter, leading to rolling a patient on and off the device. This process of rolling a patient presents difficulties especially with obese patients or patients with spinal or neck injuries. Rolling a patient also increases the risk of a patient being rolled too far and ending up rolling to the floor. The movement of a patient may be delayed as it is awkward and cumbersome to remove a patient from the existing stretcher. Another art is a plastic board. Pulling a patient across a plastic board to move to another hospital location or apparatus often involves jolting and/or jostling a patient in the movement process.

Prior art has wooden slats in the vinyl. This creates significant restrictions in water extraction or any water-based care of a patient. Water infiltrates the sleeves holding the wooden slats, affecting the further use of the stretcher.

Prior art, being rigid with wooden slats or tubular framing, prevents the movement of the patient in tight spaces such as narrow hallways or tight corners. In tighter situations, because of the rigidity of the stretcher, a patient must be secured to the stretcher and must be lifted vertically instead of horizontally to get around tight corners.

Prior art is a scoop stretcher, a device used to move injured people usually with a broken hip. It's also known as a clamshell, Roberson orthopedic stretcher, or just scoop stretcher. The scoop stretcher, being heavy and cumbersome, is not used in standard patient transfer. Given its rigidity, it is not used in removing patients from tight areas such as narrow hallways. It is not used in home healthcare, in bathing and transferring patients. The scoop stretcher is large and rigid and cannot be easily taken to remote, restrictive areas for rescue. When implementing the scoop stretcher, patients are often pinched when joining the two sides.

(1) Field of the Invention

This Rescue Device Serves the Field of Fire/EMS Rescue, Patient Transfer, Home Health Care, Athletics, Physical Therapy, Forestry Rescue, Survival Rescue, Military Rescue, or Wildlife Rescue.

### (2) Description of Related Art Including Information Disclosed Under 37 CFR 1.97 and 1.98

The Reeves Stretcher (U.S. Pat. No. 2,675,564A) was patented in 1942. The stretcher is made of heavy vinyl with wooden inserts and straps along the sides, used to carry a patient. The material is solid, retaining water. This will make the lift of the patient heavier, potentially injuring the responders, and potentially destroying the stretcher when used in water rescue. U.S. Pat. No. 6,907,632B2 is “A tactical stretcher used to transport accident victims, in particular, to stretcher type devices used to transport victims who have been exposed to hazardous materials. The tactical stretcher comprises of a foldable tubular frame having spreader assemblies attached thereto for securing the stretcher in a folded or unfolded position, the folded position having reduced width. A scoop stretcher and the patent number for a scoop stretcher is U.S. Pat. No. 3,125,766A. The patent was granted on Mar. 24, 1964, and the priority date was Jan. 28, 1963. The limitations of this stretcher is it's utility in water and it's rigidity. It is used primarily for hip fracture injuries and is placed under a patient and clipped together under a patient. Due to its buoyance, the scoop stretcher is challenging in water rescue. It is not used in home healthcare nor general EMS to hospital transfer. Due to its size and rigidity, it is also not easily transported to a rescue or health care scene.

### BRIEF SUMMARY OF THE INVENTION

The Tactical Rescue/Transfer Device is a light-weight device that includes two netting panels joined by a vertical fastening system from top to bottom of the device. Five hand strap handles are affixed along the outer perimeter of the two joined panels. Each strap features fastener buckles. The web strapping is connected to secure the patient in the transfer device. The outer perimeter allows for inflatable tubes. The central vertical fastening system is then released allowing for rapid, safe extraction from the stretcher.

The Tactical Rescue/Transfer Device is a foldable device and can be used in dry or water Rescue/transfers by emergency services personnel, home healthcare workers, nursing facilities, athletics, physical trainers, recreational settings, educational settings, and animal rescue specialists. The Tactical Rescue/Transfer Device is used to extricate a patient to an awaiting stretcher or the ground. The Tactical Rescue/Transfer Device is also used to move a patient from the emergency stretcher to the necessary hospital equipment such as gurney or table. The Tactical Rescue/Transfer Device is also a mechanism used in water transfer of fish or other water animals.

Current lift devices are constructed of solid non-permeable, heavy, awkward to carry, rigid material and require the patient (patient or animals) to be rolled on or off the lift device. This manual manipulation of the patient will lead to greater discomfort for the patient and even potential increased harm/injury to the injured patient.

Additionally, the present lift device is made of solid fabric with wooden stays or tubular poles that prevent extrication in tighter areas. A current lift device (Reeves) used in marine situations is made of thick non-permeable canvas or plastic that will retain water when the patient is lifted from the water making the lifting heavier for responders as it is lifting water along with the patient.

### BRIEF DESCRIPTION OF THE SEVERAL VIEWS OF THE DRAWING(S)

Referencing the four drawings, the numbers on each figure indicate the specific elements related to the five independent claims. The numbers are consistent across each figure.

Starting on the outer perimeter of FIG. 1, the straps (101, 102, 103, 104, 105, 106, 107, 108, 109, 110, 111, 112, 113, 114) are constructed with an inner and outer loop to allow for tighter or looser grasping. The protective gusset (121) that encases the zipper (fastening system), both on the front and back of the device, allows for the zipper (fastening system) to move freely without being caught on the patient's clothing or hair.

The outer perimeter of the right and left mesh panels is finished with a mesh border (116) to which the web strap handles and zipper (fastening system) are affixed inside a vinyl gusset.

FIG. 2 shows a center fastening system (117) connecting the right and left mesh panel with a parcord pull-string (120). At the top and bottom of the zipper (fastening system) is a locking flap (115 and 118 respectively).

FIG. 3 shows the separating of the right and left panels and the fastened and unfastened.

FIG. 4 shows the positioning of the patient (122) in the center of the right and left mesh panels.

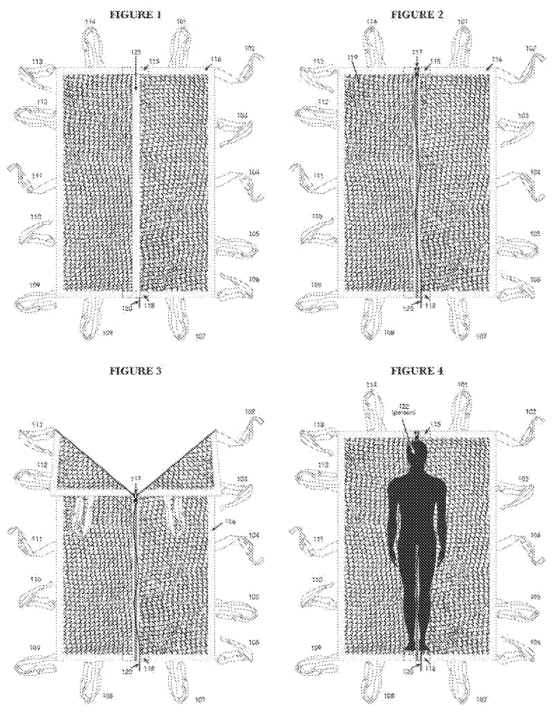

1:
A uniqueness of the Tactical Rescue/Transfer Device is the central fastener, joining the two panels, allowing a patient to remain unmoved, not needing to be rolled off the transfer device, but instead, unzipping the two panels and removing the transfer device from each side of the patient.
A uniqueness of the Tactical Rescue/Transfer Device is the composition of each panel being made of nylon/polyester mesh.
A uniqueness of the Tactical Rescue/Transfer Device is that it is comprised of mold resistant netting allowing water to flow through the device. There are mold resistant web strap handles on each side. This allows the patient to be securely lifted and transferred without carrying water—otherwise increasing water resistance and increasing the weight and thus making the transfer more difficult for Rescue/Transfer personnel.
The Tactical Rescue/Transfer Device has mold resistant webbed lift strap handles along all four sides of the perimeter, to include lift strap handles at the head and foot of the transfer device. The uniqueness of the device allows rescue personnel to transport a patient through narrow doorways without walking at the patient's sides—instead, holding the lift strap handles at the head and foot of the rescue patient.
The Tactical Rescue/Transfer Device serves to transfer a patient from a medical transport stretcher to a hospital bed, X-ray table, or hyperbaric chamber, moving the patient without future disturbance, harm to the patient resulting from excessive movement of the patient during the transfer.
The Tactical Rescue/Transfer Device serves to transfer military personnel, athletes in conditions requiring rapid and safe extrication with the great sensitivity to minimize hazardous movement and maximize safety for both patients and providers.
The Tactical Rescue/Transfer Device allows home health care providers to lift, move, bathe, and transfer a patient, moving a patient with a mechanical lift device attached to the handles of the Tactical Rescue/Transfer Device and then return the patient to their bed, placing the patient on the bed safely and with minimal risk for harm or discomfort to the patient and minimal risk of back strain on the providers.
